(19) United States
(12) Patent Application Publication
(10) Pub. No.: US 2008/0104374 A1
(43) Pub. Date: May 1, 2008

(54) HARDWARE SORTER

(75) Inventor: Magdi A. Mohamed, Schaumburg, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/554,747

(22) Filed: Oct. 31, 2006

(51) Int. Cl. G06F 15/00

(52) U.S. Cl. 712/220

(57) ABSTRACT

A hardware sorter comprises a comparator matrix (104) for checking if each number in an unsorted array input (102) is at least equal to each other number, a set of column summers (108) for counting the number of numbers that each number is at least equal to, a decoder array (112) for decoding the count, a matrix of partial row summers (116) for locating ties, A set of shift registers (130) and shift controllers (128) for shifting output (114) of the decoder array (112) to separate ties. The shifted output can be encoded row-by-row to create a permutation array (134) that determines a sort, and is used as select inputs for a set of multiplexers (136), or can be applied to switch inputs (1104) of a crossbar switch (1102).

### FIELD OF THE INVENTION

The present invention relates generally to data processing hardware.

### BACKGROUND

Sorting is used in many advanced algorithms used in data processing and signal processing. It would be desirable to provide fast sorting hardware, so that such hardware could be incorporated in Digital Signal Processor (DSP), Field Programmable Gate Array (FPGA), or Application Specific Integrated Circuit (ASIC) chips, for example.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a high level block diagram of a hardware sorter according to an embodiment of the invention;

FIG. 2 illustrates the functioning of the hardware sorter shown in FIG. 1 with numerical data;

FIG. 3 is a more detailed block diagram including a comparator used in the hardware sorter shown in FIG. 1 according to an embodiment of the invention;

FIG. 4 is a more detailed block diagram including a summer of the hardware sorter shown in FIG. 1 according to an embodiment of the invention;

FIG. 5 is a more detailed block diagram including a decoder and shift register of the hardware sorter shown in FIG. 1 according to an embodiment of the invention;

FIG. 6 is a more detailed block diagram including a partial row summer of the hardware sorter shown in FIG. 1 according to an embodiment of the invention;

FIG. 7 is a more detailed block diagram including an OR gate of the hardware sorter shown in FIG. 1 according to an embodiment of the invention;

FIG. 8 is a more detailed block diagram including a shift register and shift controller of the hardware sorter shown in FIG. 1 according to an embodiment of the invention;

FIG. 9 is a more detailed block diagram including a row encoder of the hardware sorter shown in FIG. 1 according to an embodiment of the invention;

FIG. 10 is a more detailed block diagram including a multiplexer of the hardware sorter shown in FIG. 1 according to an embodiment of the invention;

FIG. 11 shows an alternative embodiment for part of the hardware sorter shown in FIG. 1 that includes a crossbar switch;

FIG. 12 shows another alternative embodiment for part of the hardware sorter that includes a matrix of multiplexers;

FIG. 13 is block diagram including a (I,J)^{TH} digital comparator used in a variation of the hardware sorter shown in FIG. 1 according to an alternative embodiment of the invention;

FIG. 14 illustrates the functioning of the alternative embodiment hardware sorter with numerical data; and

FIG. 15 is a more detailed block diagram including a J^{TH} column summer used in the alternative embodiment sorter in conjunction with the digital comparator shown in FIG. 13.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to sorting. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

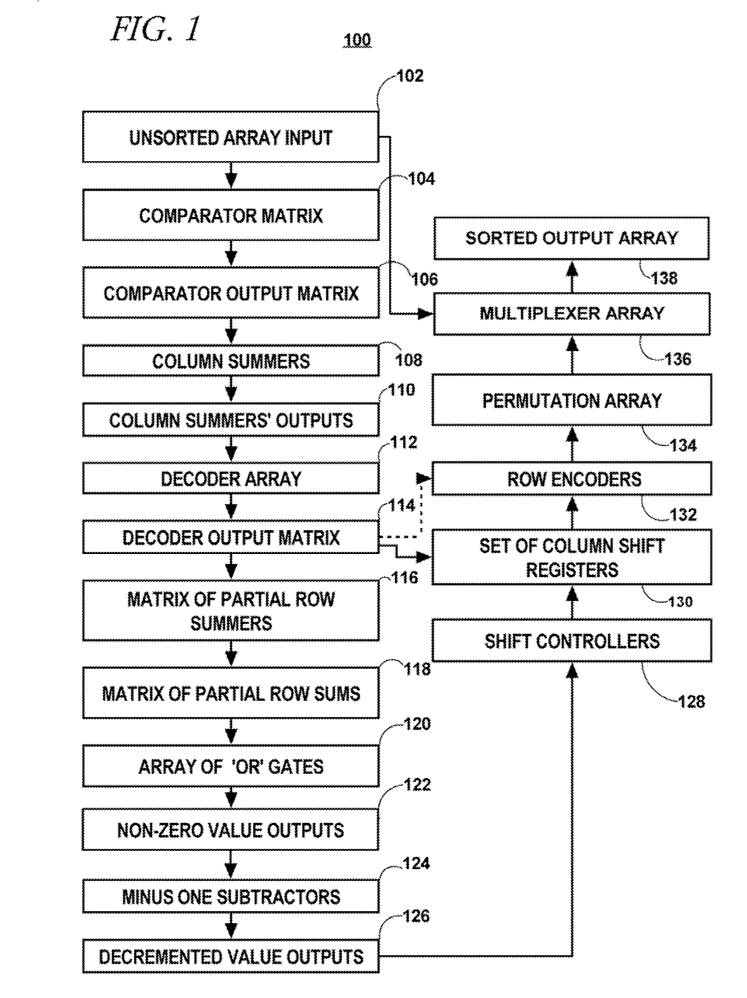

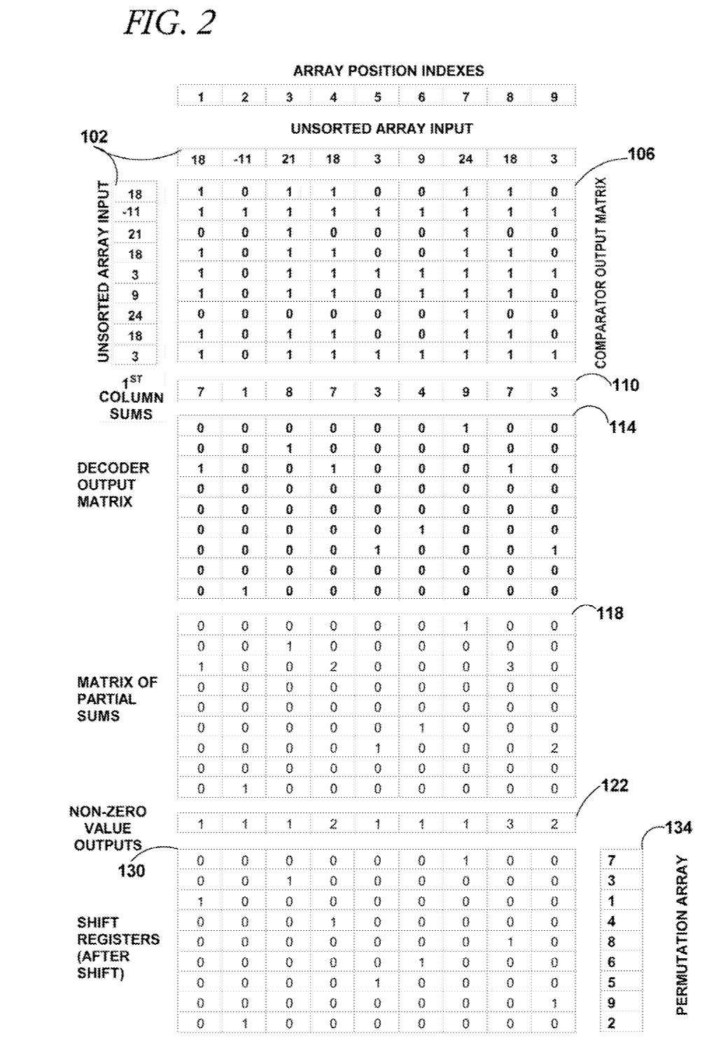

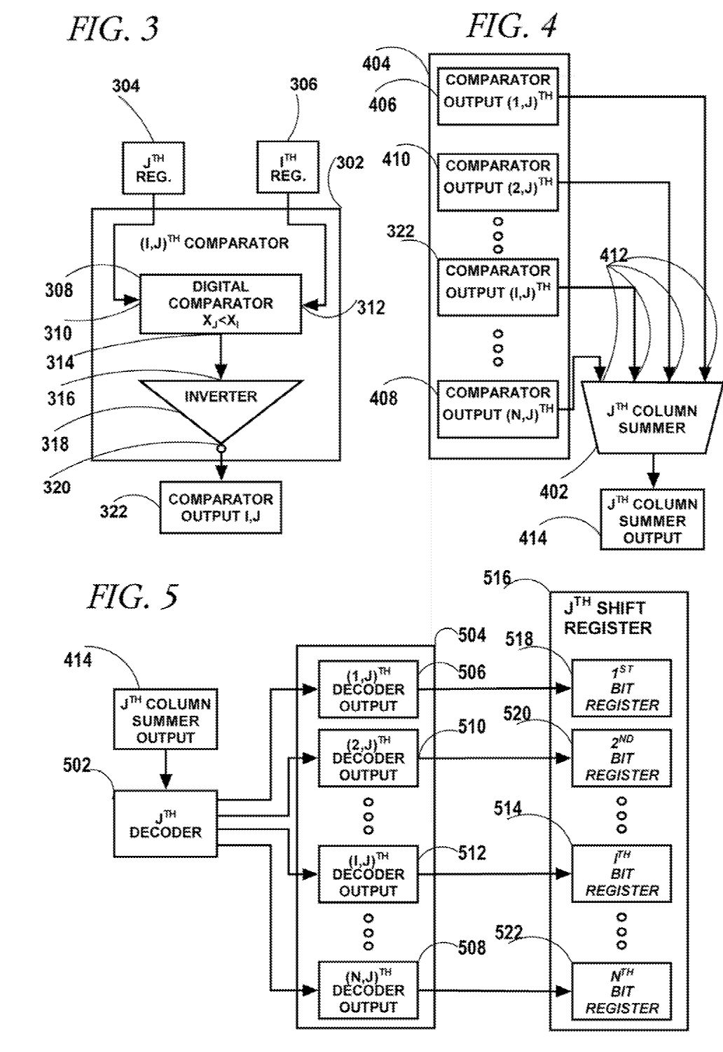

FIG. 1 is a high level block diagram of a hardware sorter 100 according to an embodiment of the invention. FIG. 2 illustrates the functioning of the hardware sorter 100 shown in FIG. 1 with numerical data, and FIGS. 3-9 illustrate various parts of the hardware sorter 100 in more detail than is shown in FIG. 1. The hardware sorter 100 has an unsorted array input 102. The unsorted array input 102 has a number N of registers, e.g., 304, 306 (FIG. 3). Each register receives one number of an array of numbers to be sorted. The unsorted array input 102 appears twice in FIG. 2.

An N by N comparator matrix 104 is coupled to the unsorted array input 102. One comparator, an (I,J)^{TH} comparator 302, of the comparator matrix 104 is shown in FIG. 3. The (I,J)^{TH} comparator 302 comprises a digital comparator 308 that includes a first input 310 coupled to a J^{TH} register 304 of the unsorted array input 102 and a second input 312 coupled to an I^{TH} register 306 of the unsorted array input 102. The digital comparator 308 outputs a binary signal (e.g., binary one) at an output 314 of the digital comparator 308 if a number in the J^{TH} register 306 is less than a number in the I^{TH} register 304. The output 314 of the digital comparator 308 is coupled to an input 316 of an inverter 318. The inverter 318 outputs a binary signal (e.g., binary one) at an inverter output 320 when the number in the J^{TH} register 306 is greater than or equal to the number in the I^{TH} register 304. The inverter output 320 is coupled to an output 322 of the comparator 302. Each (I,I)^{TH} comparator can be hardwired to output a predetermined binary number (e.g., one) because a number is always equal to itself.

The output 322 is part of an N by N comparator output matrix 106. The comparator output matrix 106 includes an output for each comparator in the comparator matrix 104. A numerical example of the contents of the comparator output matrix 106 is shown in FIG. 2.

The comparator output matrix 106 is coupled to an array of N column summers 108. A J^{TH} column summer 402 is shown in FIG. 4. FIG. 4 also shows a J^{TH} column 404 of the comparator output matrix 106. The J^{TH} column 404 of the comparator output matrix 106 includes a (1,J)^{TH} comparator output 406 through a (N,J)^{TH} comparator output 408. A (2,J)^{TH} comparator output 410 and the (I,J)^{TH} comparator output 322 are also shown in FIG. 4 for illustration. The (1,J)^{TH} through the (N,J)^{TH} comparator outputs are coupled to inputs 412 of the J^{TH} column summer 402. The J^{TH} column summer 402 sums the outputs in the J^{TH} column 404 of the comparator output matrix 106 and outputs a sum at a J^{TH} column summer output 414.

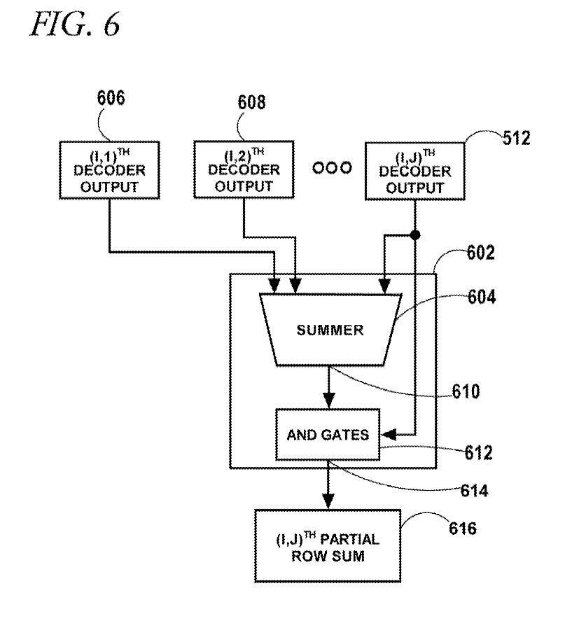

The J^{TH} column summer output 414 is one an array of N column summers' outputs 110. A numerical example of the contents of the column summers' outputs 110 is shown in FIG. 2. The N column summers' outputs 110 are coupled to array of N decoders 112. One of the N decoders 112, a J^{TH} decoder 502, is shown in FIG. 5. Outputs of the N decoders 112 form a N by N decoder output matrix 114. A J^{TH} column 504 of the decoder output matrix 114 is shown in FIG. 5. The J^{TH} column 504 includes outputs of the J^{TH} decoder 502 ranging from a (1,J)^{TH} decoder output 506 through a (N,J)^{TH} decoder output 508. A (2,J)^{TH} decoder output 510 and a (I,J)^{TH} decoder output 512 are also shown in FIG. 5. A numerical example of the contents of the N by N decoder output matrix 114 is shown in FIG. 2.

A matrix of partial row summers 116 is coupled to the N by N decoder output matrix 114. One of the matrix of partial row summers, an (I,J)^{TH} partial row summer 602 is shown in FIG. 6. The (I,J)^{TH} partial row summer 602 includes a summer 604 that is coupled to an (I,1)^{TH} output 606 through the (I,J)^{TH} output 512 of the N by N decoder output matrix 114. An (I,2)^{TH} output 608 is also shown in FIG. 6. A multibit output 610 of the summer 604 is coupled to a set of AND gates 612. The AND gates AND each bit of the multibit output 610 of the summer 604 with the (I,J)^{TH} output of the N by N decoder output matrix 114. Outputs 614 of the AND gates 612 output an (I,J)^{TH} partial row sum 616. Thus, if the (I,J)^{TH} output 512 of the N by N decoder output matrix 114 is zero, the (I,J)^{TH} partial row sum 616 will be zero and if the (I,J)^{TH} output 512 of the N by N decoder output matrix 114 is one, the (I,J)^{TH} partial row sum 616 will be equal to the sum of the values in the (I,1)^{TH} output 606 through the (I,J)^{TH} output 512 of N by N decoder output matrix 114. The (I,J)^{TH} partial row sum 616 is one element of an N by N matrix of partial row sums 118. A numerical example of the contents of the N by N matrix of partial row sums 118 is shown in FIG. 2. The first column of partial row summers 116 can be hardwired to pass the contents of the first row of the decoder output matrix 114.

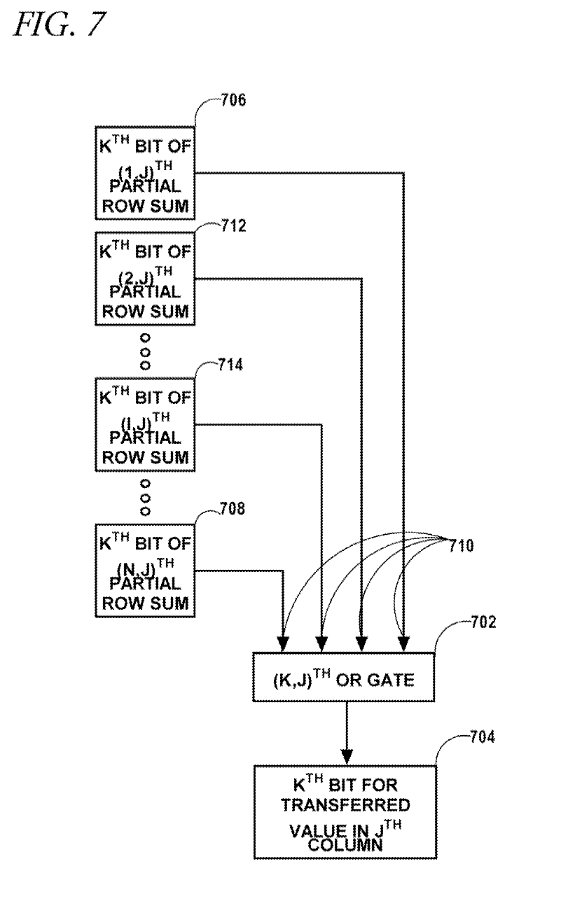

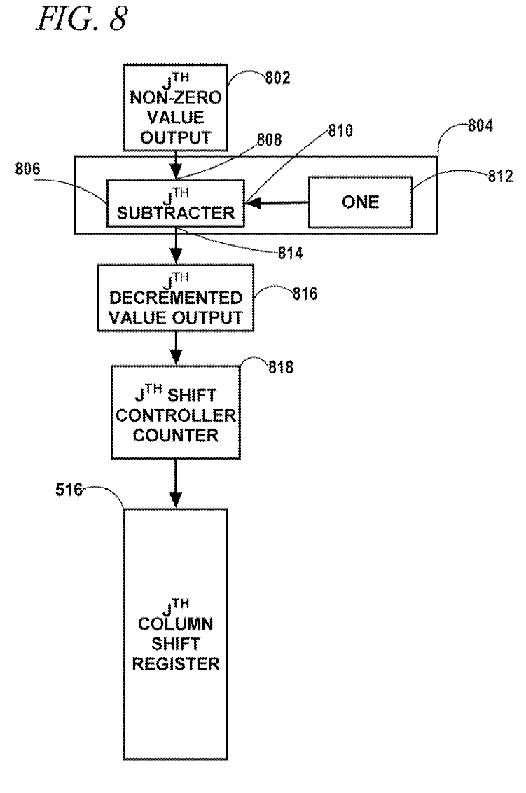

The N by N matrix of partial row sums 118 is coupled to an array of OR gates 120. Each column of the matrix of partial row sums 118 will have one non-zero value. The OR gates 120 serve to transfer the non-zero values, bit by bit to an output 704. FIG. 7 shows a (K,J)^{TH} OR gate 702 for transferring a K^{TH} bit of the non-zero value in the J^{TH} column of the matrix of partial row sums 118 to the output 704. The K^{TH} bits of the (1,J)^{TH} partial row sum 706 through (N,J)^{TH} partial row sum 708 are coupled to N inputs 710 of the (K,J)^{TH} OR gate 702. The K^{TH} bit of a (2,J)^{TH} partial row sum 712 and the K^{TH} bits of a (I,J)^{TH} partial row sum 714 are also shown. The (K,J)^{TH} OR gate 702 is one of an array of OR gates 120 used to transfer the non-zero bits from each column of the matrix of partial row sums 118. The output 704 is one of an array of non-zero value outputs 122. Within the array of non-zero value outputs 122 there is a separate binary number from each column of the matrix of partial row sums 118. A numerical example of the contents of the non-zero value outputs 122 is shown in FIG. 2.

An array of N minus one subtracters 124 is coupled to the non-zero value outputs 122. The minus one subtracters 124 serve to subtract one from each of the non-zero value outputs 122. The minus one subtracters 124 output decremented non-zero values to an array of N decremented value outputs 126. The decremented non-zero values are coupled to an array of N shift controllers 128. The array of N shift controllers 128 control binary value shifting in a set of N column shift registers 130. The shift controllers 128 shift the contents of each J^{TH} column shift register 516 by a number of places dictated by the decremented values output by the minus one subtracters 124, via the decremented value outputs 126. The set of N column shift registers 130 is, initially, loaded in parallel (via parallel inputs) from the decoder output matrix 114, so that each I^{TH} bit register 514 of each J^{TH} column shift register 516 is initially loaded with the (I,J)^{TH} decoder output 512. FIG. 5 illustrates the parallel loading of the J^{TH} column shift register 516. As shown in FIG. 5 a first bit register 518, a second bit register 520, the I^{TH} bit register 514 and an N^{TH} bit register 522 of the J^{TH} column shift register 516 are initially loaded from the (1,J)^{TH} decoder output 506, the (2,J)^{TH} decoder output 510, the (I,J)^{TH} decoder output 512 and the (N,J)^{TH} decoder output 508 respectively.

Referring to FIG. 8 one of the non-zero value outputs 122-a J^{TH} non-zero value output 802 is shown coupled to one of the minus one subtracters 124-a J^{TH} minus one subtracter 804. The J^{TH} minus one subtracter 804 comprises a J^{TH} subtracter 806 that has a first input 808 coupled to the J^{TH} non-zero value output 802 and a second input 810 coupled to binary one 812. An output 814 of the J^{TH} subtracter 804 is coupled to a J^{TH} decremented value output 816 which is one of the decremented value outputs 126. The J^{TH} decremented value output 816 is coupled to a J^{TH} shift controller 818. The J^{TH} shift controller 818 is coupled to the J^{TH} column shift register 516. The J^{TH} shift controller 818 drives the J^{TH} column shift register 516 to shift (e.g., shift down) binary values stored in the J^{TH} column shift register 516 by a number of places indicated by the J^{TH} decremented value output 816. A numerical example of the contents of the set of column shift registers 130 after shifting has been completed is shown in FIG. 2.

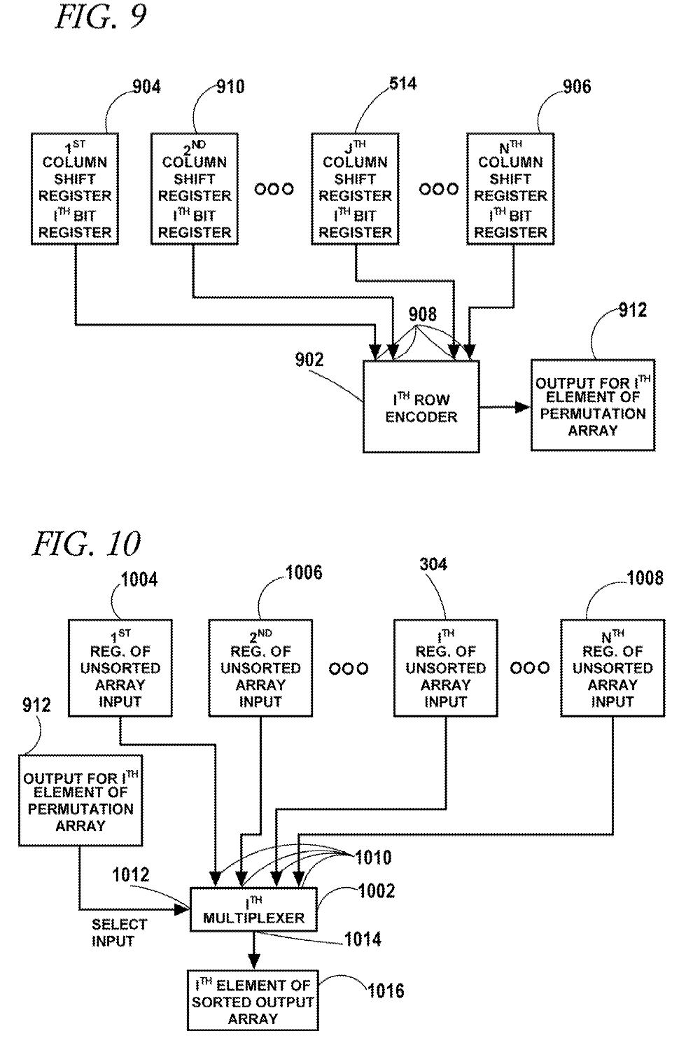

The set of N column shift registers 130 is coupled to a set of N row encoders 132. The row encoders 132 encode the contents of the shift registers row-by-row and thereby generate a permutation array 134. FIG. 9 shows one of the set of N row encoders 132—an I^{TH} row encoder 902. Each I^{TH} row encoder 902 encodes a bit pattern stored in the I^{TH} bit registers of the set of N column shift registers 130. The encoding is done after the bits in the N column shift registers 130 have been shifted. As shown in FIG. 9, the I^{TH} bit register of a first column shift register 904 through a N^{TH} column shift register 906 are input to inputs 908 of the I^{TH} row encoder 902. An I^{TH} bit register of a second column shift register 910 and the I^{TH} bit register 514 of the J^{TH} column shift register 516 are also shown in FIG. 9. The I^{TH} row encoder 902 has an output 912 for an I^{TH} element of a permutation array. Permutation arrays are sometimes used as the output of a sorter. A permutation array presents indexes that refer to positions in the unsorted array input 102 in an order according to the magnitude of the values that the indexes refer to. For example, in the case that the largest value (e.g., 2.4 is presented at the 7^{TH} unsorted array input 102, index 7 will appear first in the permutation array. A numerical example of the contents of the permutation array 134 is shown in FIG. 2.

The permutation array 134 is coupled to a multiplexer array 136. The unsorted array inputs 102 are also coupled to data inputs of each multiplexer in the multiplexer array 136. An I^{TH} multiplexer 1002 of the multiplexer array 136 is shown in FIG. 10. As shown in FIG. 10 a first element 1004, a second element 1006, the I^{TH} element 304, and an NTH element 1008 of the unsorted array input 102 are coupled to data inputs 1010 of the I^{TH} multiplexer 1002. The output 912 for the I^{TH} element of a permutation array 134, is coupled to select inputs 1012 of the I^{TH} multiplexer 1002. An output 1014 of the I^{TH} multiplexer provides an I^{TH} element 1016 of a sorted output array 138.

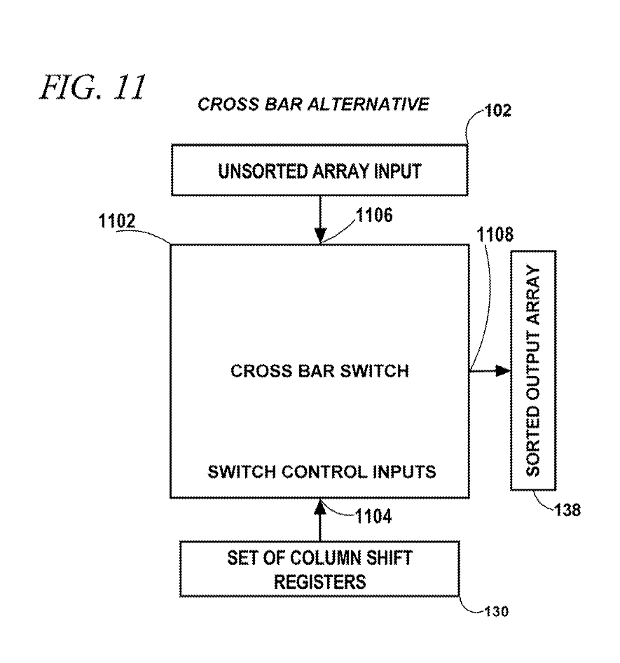

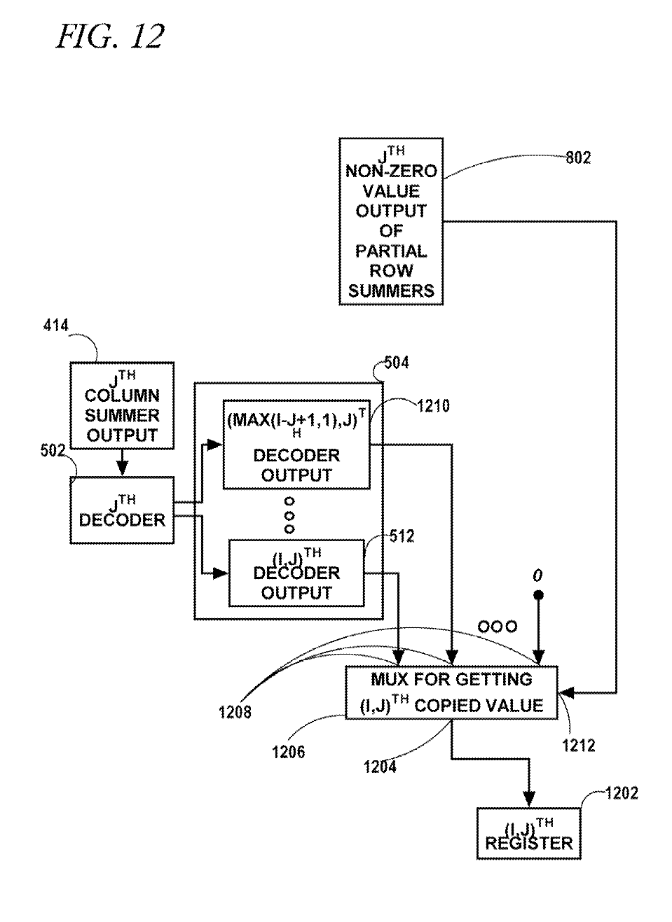

FIG. 11 shows an alternative embodiment in which an N by N crossbar switch 1102 is used instead of the row encoders 132 and multiplexer array 136. In the alternative shown in FIG. 11 parallel outputs of the set of column shift registers 130 are coupled to switch control inputs 1104 of the crossbar switch 1102. The unsorted array input 102 is coupled to N data inputs 1106 of the crossbar switch 1102 and the sorted array output 138 is received from N data outputs 1108 of the crossbar switch 1102. The contents of the shift registers 130 are useful after shifting has been completed. Each (I,J)^{TH} switch of the crossbar switch 1102 is controlled by the I^{TH} bit register 514 of the J^{TH} column shift register 516. Note that signal pathways of the crossbar switch are multibit, in order to transfer multibit numbers from the unsorted array input 102 to the sorted output array 138. Each (I,J)^{TH} switch is therefore also multi-bit.

In a worst case scenario in which all the input numbers are tied the N^{TH} column shift register (not shown) in the set of column shift registers 130 will have to be shifted through N positions. For certain applications of the hardware sorter 100 it may be undesirable to have to wait a time required to shift N times. FIG. 12 shows an alternative in which the set of column shift registers 130 is replaced by a matrix of non-shifting registers including a representative (I,J)^{TH} register 1202 shown in FIG. 12. The (I,J)^{TH} register 1202 receives it's data from a data output 1204 of an (I,J)^{TH} multiplexer 1206. The (I,J)^{TH} multiplexer 1206 is one of an N−1 by N matrix of multiplexers that serve the matrix of non-shifting registers. (These are distinct from the multiplexer array 136.) Data inputs 1208 of the (I,J)^{TH} multiplexer 1206 are coupled to a sequence of elements of the J^{TH} column 504 of the decoder output matrix 114 from a (MAX(I−J+1,1),J)^{TH} output 1210 to the (I,J)^{TH} 512 decoder output. A set of data select inputs 1212 of the (I,J)^{TH} multiplexer 1206 are coupled to the J^{TH} non-zero value output 802 of the non-zero value outputs 122. If the J^{TH} non-zero value output 802 indicates that a number in the J^{TH} position of the unsorted array input 102 is not tied with other numbers or is the first (starting from the left) of tied numbers, then the (I,J)^{TH} multiplexer 1206 will copy the (I,J)^{TH} decoder output 512 to the (I,J)^{TH} register 1202. However, if a number in the J^{TH} position of the unsorted array input 102 is tied with other numbers and is not the first then the J^{TH} non-zero value output 802 will be greater than one, and the (I,J)^{TH} multiplexer 1206 will select decoder output matrix 114 element in the J^{TH} column 504 but above (having a lower row index value compared to) the I^{TH} output 512. The value of the J^{TH} non-zero value output 802 applied to the data select inputs 1212 effectively counts backwards from the (I,J)^{TH} 512 decoder output. In as much as (as described above) ties are identified from left to right, there can be no more than J ties detected in the J^{TH} column of the decoder output matrix 114 (as identified in the matrix of partial row sums), so it will never be necessary to move entries in the J^{TH} column down by more than J−1 positions, hence the first argument I-J in the row index MAX(I−J+1,1). For elements (I,J) on the diagonal of the decoder output matrix 114 (e.g. (I,I)^{TH} elements) and below, the row index I−J+1 points to an element within the decoder output matrix 114. For elements above the diagonal the row index I−J+1 is less than one, and so refer to a non-existent element of the decoder output matrix 114, hence the use of MAX. Also for elements of the matrix of non-shifting registers above the diagonal (e.g., 1202, if I<J) the data inputs 1208 beyond that connected to the (1,J)^{TH} decoder output 506, may be hardwired to zero. This is represented in FIG. 12 by the multiplexer data input 1208 labeled (I−J+1)^{TH}. For elements on or below the diagonal this is unnecessary because the indexes from (MAX(I−J+1,1),J)^{TH} to the (I,J)^{TH} refer to actual decoder output matrix 114 elements. The matrix of non-shifting registers including the representative (I,J)^{TH} register 1202 takes the place of set of column shift registers. Accordingly, the matrix of non-shifting registers can be coupled the row encoders 132 in the embodiment shown in FIG. 1 or to the switch control inputs 1104 of the crossbar switch 1102 in the embodiment shown in FIG. 11.

In the hardware sorter 100, the matrix of partial row summers 116, the array of OR gates 120, the minus one subtracters 124, the shift controllers 128 and the set of column shift registers 130 are used to handle ties in the numbers input at the unsorted array input. For a use in which there is no possibility of ties, the foregoing components can be eliminated and the decoder output matrix 114 used directly, e.g., as input to the row encoders 132 or input to the switch control inputs 1104 of the crossbar switch 1102.

The matrix of partial row summers 116 initially identifies ties which are associated with partial row sums 118 greater than one. As discussed above in identifying ties, the contents of the decoder output matrix 114 are summed from left to right, however in practice the output of the decoder output matrix 114 can be summed from right to left or in another order.

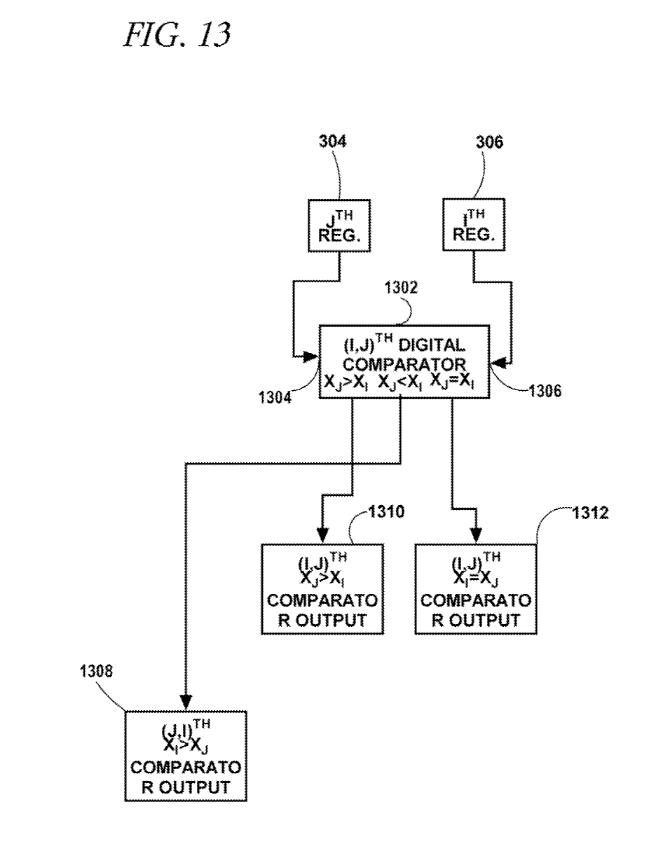

FIGS. 13-15 shown another alternative embodiment. FIG. 13 is block diagram including a (I,J)^{TH} digital comparator 1302 used in a variation of the hardware sorter 100 according to an alternative embodiment of the invention. The digital comparator 1302 has a first input 1304 coupled to the J^{TH} register 304 of the unsorted array input 102, a second input 1306 coupled to the I^{TH} register 306 of the unsorted array input, a X_{I}>X_{J} output 1308, an X_{J}>X_{I} output 1310 and an X_{I}=X_{J} output 1312.

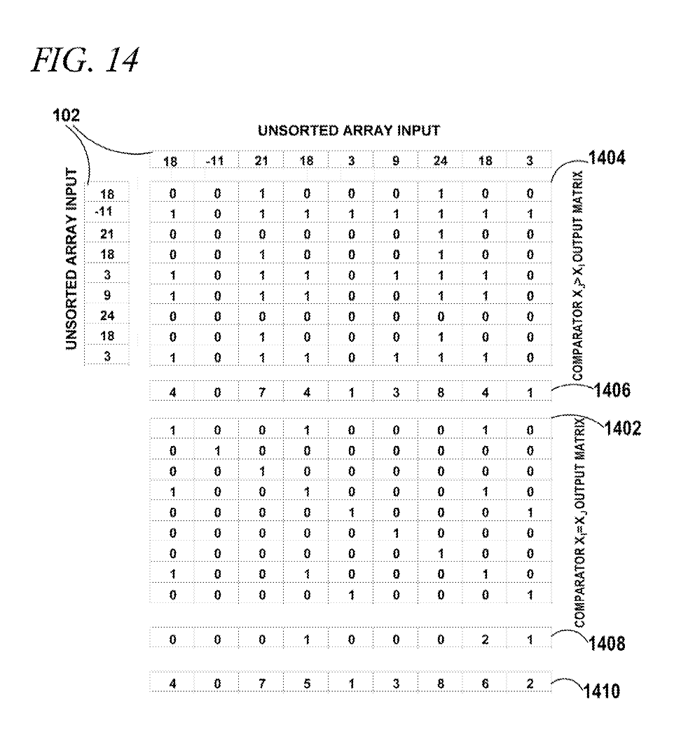

The (I,J)^{TH} digital comparator 1302 is one of a matrix of comparators. The matrix of comparators provides a matrix of outputs X_{J}>X_{I} including the output 1310, and a matrix of outputs X_{I}=X_{J} including the output 1312. In practice, only comparators either above or below the diagonal of the matrix are required. In the former case the comparator matrix is upper triangular and the latter lower triangular shape. This is because X_{I}=X_{J} is symmetric in I and J, and the X_{I}>X_{J} output 1308, of the (I,J)^{TH} digital comparator 1302 can be used for a (J, I)^{TH} output equivalent to the X_{J}>X_{I} output 1310. A numerical example of the contents of such the X_{I}=X_{J} comparator output matrix 1402 and a numerical example of the contents of the X_{J}>X_{I} comparator output matrix 1404 are shown in FIG. 14. In practice only X_{I}=X_{J} comparator outputs either above of below the diagonal or 1402 are required.

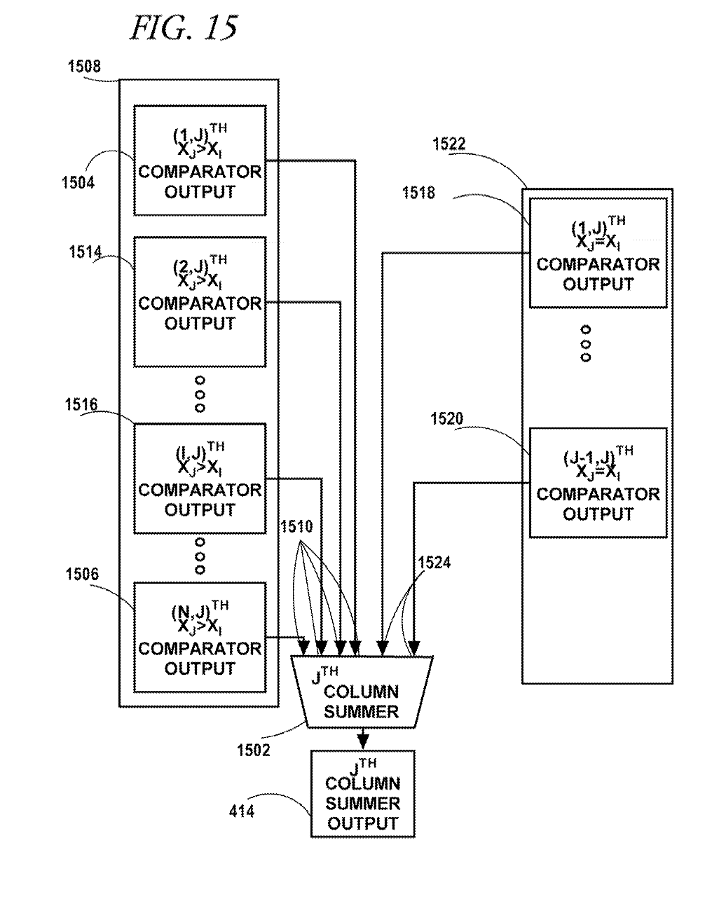

FIG. 15 is a more detailed block diagram including a J^{TH} column summer 1502 used in an alternative sorter in conjunction with the digital comparator 1302 shown in FIG. 13. The J^{TH} column summer 1502 is one of an array of N column summers. A (1,J)^{TH} X_{J}>X_{I} comparator output 1504 through a (N,J)^{TH} X_{J}>X_{I} comparator output 1506 of a J^{TH} row 1508 of the X_{J}>X_{I} comparator output matrix 1404 are coupled to a first set of inputs 1510 of the J^{TH} column summer 1502. A (2,J)^{TH} X_{J}>X_{I} comparator output 1514 and a (I,J)^{TH} X_{J}>X_{I} comparator output 1516 are also shown. A (1,J)^{TH} X_{J}=X_{I} comparator output 1518 through a (J−1,J)^{TH} X_{J}=X_{I} comparator output 1520 of a J^{TH} row 1522 of the X_{J}=X_{I} comparator output matrix 1402 are coupled to a second set of inputs 1524 of the J^{TH} column summer 1502. The (1,J)^{TH} X_{J}=X_{I} comparator output 1518 through the (J−1,J)^{TH} X_{J}=X_{I} comparator output 1520 are above the diagonal. Alternatively outputs below the diagonal of the X_{J}=X_{I} comparator output matrix 1402 could be used. Also, alternatively an extra one e.g., from the diagonal of the X_{J}=X_{I} comparator output matrix 1402 could be included. In FIG. 4 a first array of column sums 1406 of the X_{J}>X_{I} comparator output matrix 1404 is shown. As shown equal numbers, for example 18 appearing the first, fourth and eighth positions, result in equal sums in the array of column sums 1406. If left unresolved these equal sums would lead to multiple copies of the same number being routed to the same position in the sorted output array 138. A second array of column sums 1408 includes sums, above the diagonal of each J^{TH} column of the X_{I}=X_{J} comparator output matrix 1402. It should be observed that equal numbers in the unsorted array input 102, for example 18, do not yield equal sums. Rather the sums count from zero for each successive appearance of a duplicate number. This progression leads, ultimately, to successive appearance of the same number (e.g., 18) being shifted into successive positions in the sorted output array 138. A third array of column sums 1410 sums the first array of columns sums 1406 and the second array of column sums 1408. The third array of column sums 1410 is what is computed by the array of N column summers that includes the J^{TH} column summer 1502. The J^{TH} column summer 1502 is coupled to the J^{TH} column summer output 414 referenced above.

The J^{TH} column summer output 414 is coupled to the J^{TH} decoder 502 as shown in FIG. 5. However, according to the embodiment shown in FIG. 15, neither the array of shift registers including the J^{TH} column shift register 516 nor the N−1 by N matrix of multiplexers including the (I,J)^{TH} multiplexer 1206 is needed, because ties have already been resolved by the array of column summers (e.g., 1502). Thus, the decoder output matrix 114 can be coupled directly to the switch control inputs 1104 of the crossbar switch, or to the row encoders 132. The latter is indicated in FIG. 1 by a dashed arrow connecting the decoder output matrix 114 and the row encoders 132.

It will be apparent to one skilled in the art that the teachings herein provide for sorting in increasing or deceasing order.

It will also be apparent to one skilled in the art that the teachings herein can be applied to for sorting numbers provided in any format such as integer, fixed point, floating point, signed or unsigned representation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A hardware sorter comprising:
an unsorted array input for receiving an unsorted array of numbers, said array input comprising a number N of registers, wherein each register accommodates an element of said unsorted array;
a matrix of comparators wherein each (I,J)^{TH} comparator in said matrix of comparators comprises:
a first input coupled to a I^{TH} register of said unsorted array input; a second input coupled to a J^{TH} register of said unsorted array input; and
one or more outputs;
a first array of N column summers, wherein each J^{TH} column summer comprises:
a plurality of inputs each of which is coupled to one of said one or more outputs of said comparators; and
an output.

2. The hardware sorter according to claim 1 further comprising:
an array of N decoders, wherein each J^{TH} decoder comprises:
an input coupled to said output of said J^{TH} column summer; and
a J^{TH} column of N outputs;
whereby, said N outputs of said N decoders form an N by N decoder output matrix.

3. The hardware sorter according to claim 2 further comprising:
an array of N row encoders, wherein each I^{TH} row encoder comprises:
N inputs, and each J^{TH} input of each I^{TH} row encoder is coupled to an (I,J)^{TH} output of said N by N decoder output matrix; and
an encoder output;
whereby, said encoder outputs of said N row encoders, together output a permutation array.

4. The hardware sorter according to claim 2 further comprising:
a crossbar switch comprising:
N data inputs coupled to said N registers of said unsorted array input of the hardware sorter;
N data outputs; and
an N by N array of crossbar switches wherein each (I,J)^{TH} crossbar switch is coupled to an (I,J)^{TH} output of said N by N decoder output matrix.

5. The hardware sorter according to claim 2 wherein:
said one or more outputs of each (I,J)^{TH} comparator comprise:
a greater than or equal to output; and
wherein said plurality of inputs of each J^{TH} summer are coupled to said
greater than or equal to outputs of comparators in a J^{TH} column of said matrix of comparators.

6. The hardware sorter according to claim 2 wherein said one or more outputs of each (I,J)^{TH} comparator comprises:
an equal to output; and
one or more outputs selected from the group consisting of a greater than output and a less than output; and

7. The hardware sorter according to claim 2 wherein:
said matrix of comparators comprises a triangular matrix of comparators.

8. The hardware sorter according to claim 7 wherein said one or more outputs of each (I,J)^{TH} comparator comprise:
a greater than output;
a less than output; and
an equal to output.

9. The hardware sorter according to claim 8 wherein:
an output selected from said greater than output of said (I,J)^{TH} comparator and said less than output of said (I,J)^{TH} comparator serves as an output selected from the group consisting of a (J,I)^{TH} less than output and a (J,I)^{TH} greater than output, respectively.

10. The hardware sorter according to claim 9 wherein:
one or more of said plurality of inputs of each J^{TH} summer are coupled to N J^{TH} column comparator outputs selected from the group consisting of said greater than output and said less than output and wherein one or more of said plurality of inputs of one or more of said N column summers are coupled to said equal to output.

11. The hardware sorter according to claim 2 further comprising:
an N by N matrix of partial row summers wherein each (I,J)^{TH} partial row summer comprises:
J inputs coupled to a (I,1)^{TH} through a (I,J)^{TH} output of said N by N decoder output matrix, respectively;
an output; and
wherein each (I,J)^{TH} partial row summer is adapted to output a value equal to a sum of said (I,1) TH though said (I,J)^{TH} output of said N by N decoder output matrix if said (I,J)^{TH} output of said N by N decoder output matrix is non-zero, and to output zero if said (I,J)^{TH} output of said N by N decoder output matrix is zero;
an array of OR gates wherein each (K,J)^{TH} OR gate comprises:
N inputs and an output and wherein each (K,J)^{TH} OR gate is coupled to a K^{TH} bit of said output of a (1,J)^{TH} through a (N,J)^{TH} output of said partial row summer for transferring said K^{TH} bit to said output of said (K,J)^{TH} OR gate.

12. The hardware sorter according to claim 11 further comprising:
an array of N subtracters, wherein each J^{TH} subtracter comprises:
an input coupled to said output of said OR gates for a J^{TH} column of said partial row summer, whereby said subtracter receives a partial row sum from said J^{TH} column;
a subtracter output; and
wherein, each subtracter is adapted to subtract one from said partial row sum received from said J^{TH} column.

13. The hardware sorter according to claim 12 further comprising:
an array of N shift registers, wherein each J^{TH} shift register comprises:
N bit registers, and each I^{TH} bit register of each J^{TH} shift register is coupled to an (I,J)^{TH} output of said N by N decoder output matrix; and
an array of N shift controllers, wherein each J^{TH} shift controller is coupled to the J^{TH} shift register, and the J^{TH} subtracter, and is adapted to drive the J^{TH} shift register in order to shift values stored in the J^{TH} shift register by a number of places equal to an output of the J^{TH} subtracter.

14. The hardware sorter according to claim 13 wherein:
each of said array of N shift registers further comprises N parallel outputs; and
the hardware sorter further comprises:
a crossbar switch comprising:
N data inputs coupled to said N registers of said array input of the hardware sorter;
N data outputs; and
an N by N array of switches wherein each (I,J)^{TH} switch is coupled to an I^{TH} parallel output of a J^{TH} shift register of said N shift registers.

15. The hardware sorter according to claim 13 wherein:
each of said array of N shift registers further comprises N parallel outputs; and
the hardware sorter further comprises:
an array of N row encoders, wherein each I^{TH} row encoder comprises:
N inputs, and each J^{TH} input of each I^{TH} row encoder is coupled to an I^{TH} parallel output of a J^{TH} shift register of said N shift registers; and
an encoder output;
an array of N multiplexers wherein each I^{TH} multiplexer comprises:
a select input coupled to said encoder output of said I^{TH} row encoder;
N data inputs, wherein each J^{TH} data input is coupled to a J^{TH} register of said unsorted array input; and
a multiplexer output.

16. The hardware sorter according to claim 11 further comprising:
an N by N array of registers;
an N by N array of first multiplexers wherein each (I,J)^{TH} multiplexer comprises:
a data output coupled to an (I,J)^{TH} register of said N by N array of registers;
a plurality of data inputs including an input coupled to said (I,J)^{TH} output of said decoder of said N by N decoder output matrix, and one or more additional data inputs coupled to outputs adjacent said (I,J)^{TH} output of said decoder of said N by N decoder output matrix;
a data select input coupled to said output of said OR gates for a J^{TH} column of said partial row summer.

17. The hardware sorter according to claim 16 further comprising:
a crossbar switch comprising:
N data inputs coupled to said N registers of said array input of the hardware sorter;
N data outputs; and
an N by N array of switches wherein each (I,J)^{TH} switch is coupled to said (I,J)^{TH} register of said N by N array of registers.

18. The hardware sorter according to claim 16 further comprising:
an array of N row encoders, wherein each I^{TH} row encoder comprises:
N inputs, and each J^{TH} input of each I^{TH} row encoder is coupled to said (I,J)^{TH} register of said N by N array of registers; and
an encoder output;
an array of N second multiplexers wherein each I^{TH} second multiplexer comprises:
a select input coupled to said encoder output of said I^{TH} row encoder;
N data inputs, wherein each J^{TH} data input is coupled to a J^{TH} register of said unsorted array input; and
a multiplexer output.
